(19) United States
(12) Patent Application Publication
(10) Pub. No.: US 2019/0368763 A1
(43) Pub. Date: Dec. 5, 2019

(54) VIRTUAL REALITY AND AUGMENTED REALITY INTEGRATED HVAC SYSTEMS

(71) Applicant: Johnson Controls Technology Company, Auburn Hills, MI (US)

(72) Inventor: Aneek M. Noor, Wichita, KS (US)

(21) Appl. No.: 16/001,702

(22) Filed: Jun. 6, 2018

Related U.S. Application Data
(60) Provisional application No. 62/680,291, filed on Jun. 4, 2018.

(51) Int. Cl. F24F 11/523; G05B 15/02; F24F 11/56; F24F 11/30; G06T 19/00

(52) U.S. Cl. CPC F24F 11/523; G05B 15/02; F24F 2120/14; F24F 11/30; G06T 19/006; F24F 11/56

(57) ABSTRACT

A climate management system includes a controller configured to control operation of the climate management system to control climate characteristics in a building. The climate management system also includes virtual reality or augmented reality (VR/AR) equipment that includes a display and is configured to be communicatively coupled to the controller. The VR/AR equipment includes a memory device and a processor, and the memory device includes instructions that, when executed by the processor, cause the processor to send a command to the controller based on a user input received with the VR/AR equipment.

### CROSS REFERENCE TO RELATED APPLICATIONS

This application claims priority from and the benefit of U.S. Provisional Application Ser. No. 62/680,291, entitled “VIRTUAL REALITY AND AUGMENTED REALITY INTEGRATED HVAC SYSTEMS,” filed Jun. 4, 2018, which is hereby incorporated by reference.

### BACKGROUND

The present disclosure relates generally to heating, ventilation, and air conditioning (HVAC) systems. A wide range of applications exist for HVAC systems. For example, residential, light commercial, commercial, and industrial HVAC systems are used to control temperatures and air quality in residences and other buildings. Certain HVAC units can be dedicated to either heating or cooling, although many HVAC units are capable of performing both functions. HVAC units may also provide ventilation to a conditioned interior space. In general, HVAC systems operate by implementing a thermodynamic cycle in which a refrigerant undergoes alternating phase changes to remove heat from or deliver heat to a conditioned interior space of a building. Heating may also be provided by heat pumps, gas furnace heat exchangers, electric resistance heat, or steam or hot water coils. Similar systems are used for vehicle cooling, and as well as for other types of general refrigeration, such as refrigerators, freezers, and chillers.

HVAC systems generally include control devices, such as thermostats, via which a person may alter operational settings associated with the HVAC system. For instance, temperature settings may be adjusted via control devices. Moreover, control devices may provide users with information regarding the HVAC system. However, in some cases, the amount of information available may be limited and/or only accessible when directly interacting with the control device. That is, users may only be able to access information about an HVAC system when in close physical proximity to the control device. Accordingly, it may be desirable to provide users with the ability to access information about an HVAC system as well as make adjustments to operational settings of the HVAC system without interacting directly with the control device.

### SUMMARY

The present disclosure relates to a climate management system that includes a controller configured to control operation of the climate management system to control climate characteristics in a building. The climate management system also includes virtual reality or augmented reality (VR/AR) equipment that includes a display and is configured to be communicatively coupled to the controller. The VR/AR equipment includes a memory device and a processor, and the memory device includes instructions that, when executed by the processor, cause the processor to send a command to the controller based on a user input received with the VR/AR equipment.

The present disclosure also relates to a climate management system that includes a control system configured to control climate characteristics in a building. The control system includes a memory device and a processor. The memory device includes instructions that, when executed by the processor, cause the processor to receive a user input via virtual reality or augmented reality (VR/AR) equipment, control operation of climate control equipment via a thermostat of the climate management system based on the user input, and display, via a display of the VR/AR equipment, a screen comprising operational information of the climate management system.

The present disclosure further relates to a climate management system that includes a controller configured to control operation of a heating, ventilation, and air conditioning (HVAC) system to control climate characteristics in a building. The climate management system also includes virtual reality or augmented reality (VR/AR) equipment that includes a display. The VR/AR equipment is configured to be communicatively coupled to the controller via a mobile device and configured to control the HVAC system via the mobile device and the controller.

### BRIEF DESCRIPTION OF THE DRAWINGS

FIG. 1 is a perspective view of an embodiment of a heating, ventilation, and air conditioning (HVAC) system for building environmental management, in accordance with aspects of the present disclosure;

FIG. 2 is a perspective view of an embodiment of a packaged HVAC unit of the HVAC system of FIG. 1, in accordance with aspects of the present disclosure;

FIG. 3 is a perspective view of an embodiment of a residential HVAC system, in accordance with aspects of the present disclosure;

FIG. 4 is a schematic diagram of an embodiment of a vapor compression system that may be used in the packaged HVAC system of FIG. 2 and/or the residential HVAC system FIG. 3, in accordance with aspects of the present disclosure;

FIG. 5 is a schematic diagram of an embodiment of an HVAC system, in accordance with aspects of the present disclosure;

FIG. 6 is a block diagram of an embodiment of an application that may be used with the HVAC system of FIG. 5, in accordance with aspects of the present disclosure;

FIG. 7 is a block diagram of an embodiment of a gesture library module, in accordance with aspects of the present disclosure;

FIG. 8 is an illustration of an embodiment of a user interface of the application of FIG. 6, in accordance with aspects of the present disclosure;

FIG. 9 is a perspective view of an embodiment of an HVAC system, illustrating content provided by VR/AR equipment to a user, in accordance with aspects of the present disclosure; and

FIG. 10 is a diagram of an embodiment of a residence, illustrating a piping layout that VR/AR equipment may present to a user, in accordance with aspects of the present disclosure.

### DETAILED DESCRIPTION

The present disclosure is directed to an HVAC system having integrated virtual reality (VR) and/or augmented reality (AR) features. As discussed below, users of virtual reality equipment and augmented reality equipment, which can be communicatively coupled to a control device of an HVAC system, may control the HVAC system with the assistance of the VR and/or AR equipment. For example, users may alter settings typically adjustable via the control device via interaction with the VR or AR equipment. Additionally, VR and AR equipment may be utilized to provide users with information regarding an HVAC system. For instance, data associated with an HVAC system may be presented via the VR or AR equipment. Moreover, installation, maintenance, and/or repair instructions may be presented via the VR or AR equipment. Accordingly, the presently disclosed techniques enable VR and AR control of HVAC systems, as well as access to information regarding the HVAC system through VR and AR equipment.

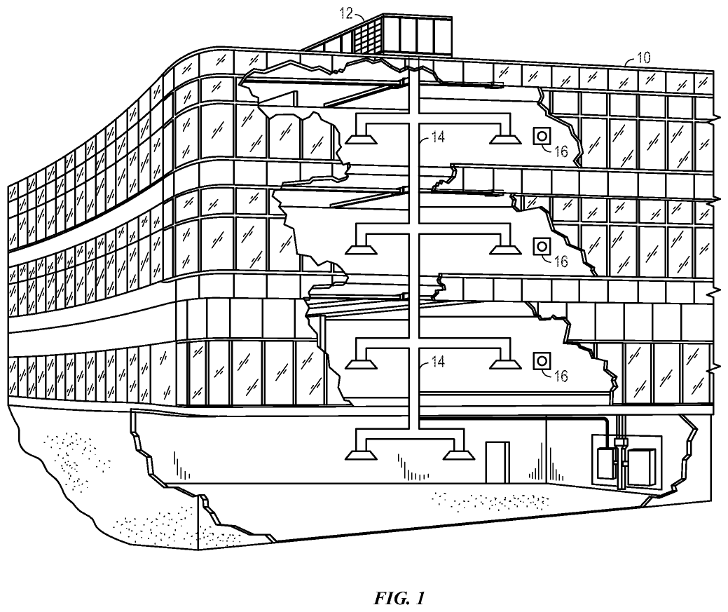

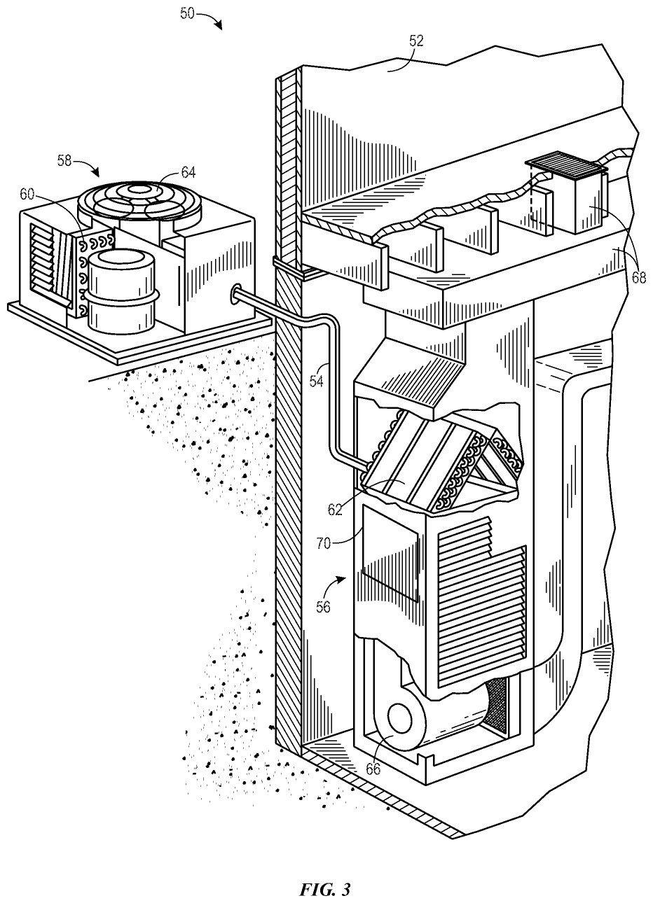

Turning now to the drawings, FIG. 1 illustrates a heating, ventilation, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

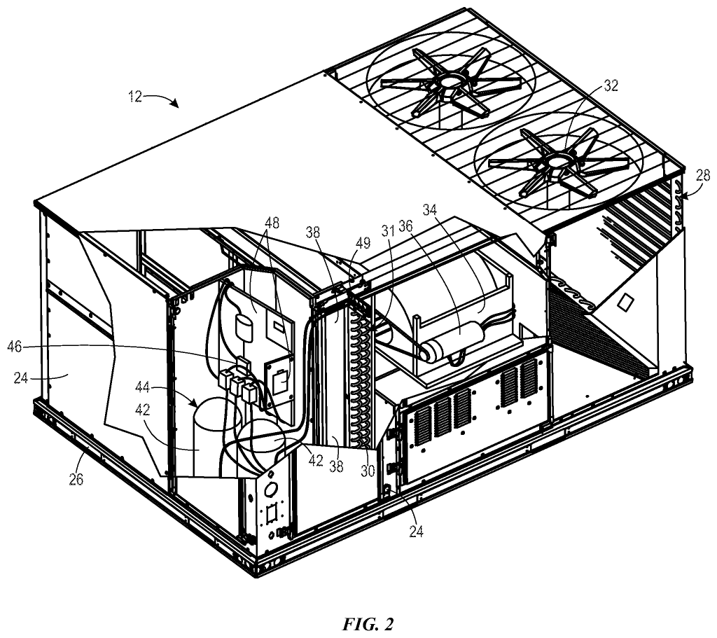

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant through the heat exchangers 28 and 30. For example, the refrigerant may be R-410A. The tubes may be of various types, such as multichannel and/or microchannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

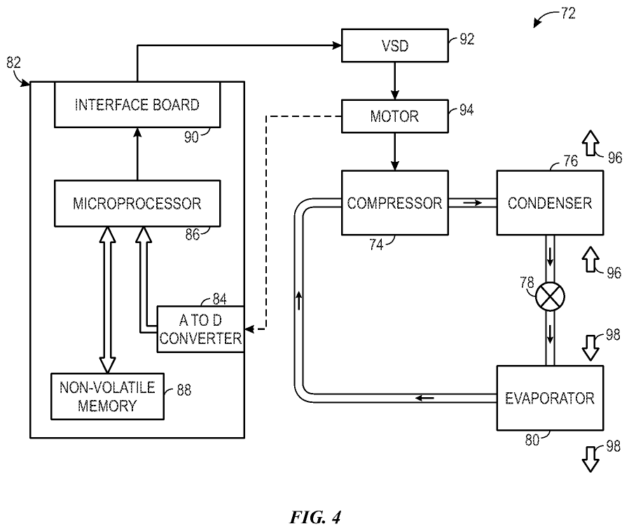

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, an HVAC system may include control devices, such as control device 16, to control various settings, functions, or other parameters associated with the HVAC system. For instance, control devices may regulate operation of the components of an HVAC unit, control the flow of air into and/or throughout a conditioned space, and designate a temperature of conditioned air supplied to the conditioned space by the HVAC system. As discussed below, virtual reality and/or augmented reality (VR/AR) equipment may be integrated into an HVAC system. As a result, the HVAC system may enable users, operators, or technicians to control the HVAC system via the VR/AR equipment as well as access information related to the HVAC system.

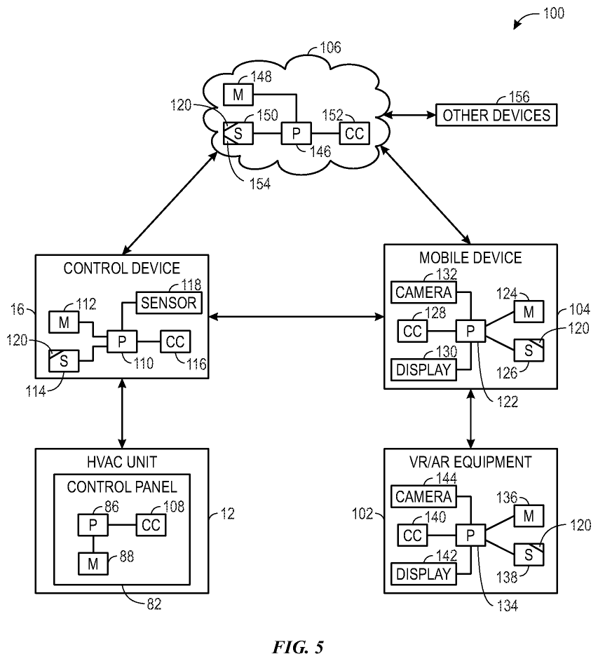

With the foregoing in mind, FIG. 5 is a schematic diagram of an HVAC system 100 including VR/AR equipment 102 configured for use with the HVAC system 100. The HVAC system 100 may be referred to as a “climate management system.” As illustrated, the HVAC system 100 includes HVAC unit 12, control device 16, which are described above, and a mobile device 104, the VR/AR equipment 102, and a cloud 106. The cloud 106 may include hardware and/or a network associated with software implemented by the HVAC unit 12. For instance, as discussed below, the cloud 106 may be communicatively coupled to components of the HVAC system 100 and receive, process, and transmit data associated with an application run on one or more components of the HVAC system 100. Each of the HVAC unit 12, the control device 16, the mobile device 104, the VR/AR equipment 102, and the cloud 106 will be discussed individually before discussing the capabilities of the HVAC system 100.

As discussed above, the HVAC unit 12 may be an HVAC unit that provides conditioned air to a conditioned space, such as building 10. However, it should be noted the HVAC unit 12 is provided as an example of HVAC equipment that may be included in the HVAC system 100. For instance, in other embodiments, different HVAC equipment may be included in the HVAC system 100. For example, the outdoor HVAC unit 58 and indoor HVAC unit 56 of FIG. 3 may be included in the HVAC system 100 in addition to the HVAC unit 12 or in the alternative to the HVAC unit 12.

As discussed above, the HVAC unit 12 may include the control panel 82 that is configured to regulate operation of components of the HVAC unit 12. The control panel 82 includes the microprocessor 86, non-volatile memory 88, and communication circuitry 108. The microprocessor 86 may utilize the memory 88 in making determinations regarding the HVAC unit 12, such as determinations associated with the functioning of components of the HVAC unit 12. For instance, the microprocessor 86 may send commands to alter an operation of the HVAC unit 12 based on communications or data received from a controller, such as the control device 16, via the communication circuitry 108. The communication circuitry 108 may enable the control panel 82 to communicate with the control device 16 via wired or wireless communication. For example, the communication circuitry 108 may include wired or wireless devices, such as transmitters, receivers, or transceivers such that the microprocessor 86 can send and receive data to and from the control device 16.

The control device 16 may control operation of the HVAC unit 12 to provide conditioned air to a conditioned space and regulate the conditioned air that the HVAC unit 12 provides. The control device 16, which may be a controller, such as thermostat, may include a processing circuitry 110, non-volatile memory 112, storage 114, and communication circuitry 116. The processing circuitry 110 may receive data regarding the HVAC system 100 from the HVAC unit 12, the mobile device 104, the VR/AR equipment 102, the cloud 106, and sensors that may be included in the HVAC system 100, such as sensors included in the HVAC unit 12, the conditioned space, or the control device 16 itself. For example, the control unit 16 may include one or more sensors 118 that can collect data regarding air temperature, humidity, and other characteristics of air. The processing circuitry 110 of the control device 16 may process such data and alter an operation of the HVAC unit 12 based on the data from the sensor 118. More specifically, the processing circuitry 110 may execute instructions stored on the memory 112 and/or storage 114 to alter the operation of the HVAC unit 12.

The storage 114 may include other programming or instructions that the processing circuitry 110 may utilize to control operation of the HVAC unit 12 and/or communicate with other devices of the HVAC system 100. For example, the memory 112 and/or storage 114 may be tangible, non-transitory, computer readable mediums that store instructions executable by the processing circuitry 110 as well as data to be processed by the processing circuitry 110. By way of example, instructions stored within the memory and/or storage may include an application 120. While the application 120 is illustrated as being included in the storage 114, in other embodiments, the application 120 may be stored on the memory 112. The application 120 will be discussed below in greater detail with respect to the mobile device 104 and the VR/AR equipment 102.

The communication circuitry 116 of the control device 16 enables the control device 16 to communicate with the control panel 82 of the HVAC unit 12, the mobile device 104, the VR/AR equipment 102, and the cloud 106 via wired or wireless communication. For example, the communication circuitry 116 may include wired or wireless devices, such as transmitters, receivers, or transceivers such that the microprocessor 86 can send and receive data to and from the control device 16. For example, the communication circuitry 116 may allow communication via the internet, such as through Wi-Fi communication. The communication circuitry 116 may also allow the control device 16 to communicate with other devices via Bluetooth.

Before proceeding to discuss the mobile device 104, it should be noted that more than one control device 16 may be included in the HVAC system 100. For example, two, three, four, or more control devices 16 may be included in the HVAC system 100, and the control devices 16 may communicate with one another as well as the HVAC unit 12, mobile device 104, VR/AR equipment 102, and cloud 106 to control operation of the HVAC unit 12. In any case, the components of the HVAC system 100 may function as a control system that controls operation of the HVAC unit 12 to control climate characteristics within a conditioned space.

The mobile device 104 may be any suitable electronic device. For example, the mobile device may be a cell phone, tablet, computer, or another type electronic device. As illustrated, the mobile device includes a processing circuitry 122, non-volatile memory 124, storage 126, and communication circuitry 128. The memory 124 and/or storage 126 may be tangible, non-transitory, computer readable mediums that store instructions executable by the processing circuitry 122 as well as data to be processed by the processing circuitry 122. For example, the processing circuitry 122 may execute a version of the application 120.

In particular, the application 120, when executed by the processing circuitry 122, may cause information and settings regarding the HVAC system 100 to be presented on a display 130 of the mobile device 104. A user may interact with the application 120 via input devices included in or on the mobile device 104 such as buttons, a keyboard, a mouse, or the display 130. The mobile device 104 may be used by users to interact with the control device 16. For example, a user may be able to adjust climate characteristics of air, such as air temperature and humidity, as well as other settings that may be associated with the HVAC system 100 by interacting with the application 120. The processing circuitry 122 may process input received from the user, and the communication circuitry 128 may send signals, commands, or data to the control device 16 to alter an operation of the HVAC unit 12 based on the user input. The communication circuitry 128 enables the mobile device 104 to communicate with the control device 16, the VR/AR equipment 102, and the cloud 106. The communication circuitry 128 may include circuitry or hardware that allows for wired or wireless communication, such as transmitters, receivers, transceivers, antenna(s). For example, the communication circuitry 128 may allow the mobile device 104 to communicate via the internet, such as through Wi-Fi communication or Long-Term Evolution (LTE). Additionally, the communication circuitry 128 may enable the mobile device 104 to communicate via Bluetooth and/or Near-Field Communication (NFC).

Additionally, the mobile device 104 may include a camera 132 that can capture images and/or videos. The images and/or videos may be stored on the storage 126, the cloud 106, or both the storage 126 and the cloud 106. As discussed below, users of the VR/AR equipment 102 may interact with content collected using the camera 132.

Furthermore, it should be noted that more than one mobile device 104 may be included in the HVAC system 100. For example, two or more mobile devices 104 may be included in the HVAC system 100 and used by users to interact with the control device 16, VR/AR equipment 102, and the cloud 106 as described above.

The VR/AR equipment 102 may include virtual reality viewing devices, such as virtual reality headsets, virtual reality goggles, and virtual reality glasses. Additionally, the VR/AR equipment 102 may include augmented reality viewing devices, such augmented reality headsets and augmented reality glasses. Generally speaking, virtual reality equipment immerses users in a virtual environment and may prevent or block the users from seeing anything other than virtual reality content. For instance, virtual reality equipment may enable a user to view a display with virtual reality content and prevent him or her from viewing anything else, such as an environment surrounding the user. Augmented reality generally refers to an experience in which something is added to a user's real surroundings. For example, when using augmented reality equipment, a user may be able to view his or her real surroundings as well as something else that does not physically exist. Moreover, it should be noted that the VR/AR equipment 102 is not limited to wearable devices. Additionally, the VR/AR equipment 102 may include devices that are used alongside virtual reality viewing devices and/or augmented reality viewing devices. For example, the VR/AR equipment 102 may include devices, such as controllers or motion sensors, both of which may be used to detect user input that is used for interacting with virtual reality and/or augmented reality content. For instance, a controller or other input device, which may include physical buttons and/or a touch screen with which a user may interact, may be communicatively coupled to the VR/AR equipment 102, receive user input, and communicate the user input to the VR/AR equipment 102 for processing.

As illustrated, the VR/AR equipment 102 includes processing circuitry 134, non-volatile memory 136, storage 138, communication circuitry 140, a display 142, and a camera 144. The memory 136 and/or storage 138 may be tangible, non-transitory, computer readable mediums that store instructions executable by the processing circuitry 134 as well as data to be processed by the processing circuitry 134. For example, the processing circuitry 134 may execute a version of the application 120. Moreover, the communication circuitry 140 enables the VR/AR equipment 102 to communicate with the mobile device 104. The communication circuitry 140 also enables the VR/AR equipment 102 to communicate with the control device 16 and the cloud 106 via the mobile device 104. The communication circuitry 140 may include circuitry or hardware that allows for wired or wireless communication, such as transmitters, receivers, transceivers, antenna(s). For example, the communication circuitry 140 may allow the VR/AR equipment 102 to communicate via the internet, such as through Wi-Fi communication. Additionally, communication circuitry 140 may enable the VR/AR equipment 102 to communicate via Bluetooth and/or Near-Field Communication (NFC). Furthermore, while the VR/AR equipment 102 can communicate with the control device 16 via the mobile device 104, in some embodiments, direct communication between the communication circuitry 140 and the communication circuitry 116 of the control device 16 may occur. For example, in embodiments of the control device 16 and the VR/AR equipment 102 in which the communication circuitry 116 and the communication circuitry 140 support Bluetooth communication, direct communication between the control device 16 and the VR/AR equipment 102 may occur.

With regard to the application 120, execution of the application 120 by the processing circuitry 134 may cause virtual reality or augmented reality content to be presented to a user of the VR/AR equipment 102 via the display 142. For example, the user may be presented with a user interface with which the user can interact in order to access data and/or manage settings associated with the HVAC system 100. For instance, the user may view data associated with the HVAC unit 12 as well as adjust heating, cooling, or other settings of the HVAC system 100. User input may be detected by the VR/AR equipment 102, and the input may be processed by the processing circuitry 134 and/or communicated to the mobile device 104 via the communication circuitry 140 for processing via the processing circuitry 122. For example, as discussed below in greater detail, the VR/AR equipment 102 may detect a hand motion of a user, and the processing circuitry 134 of the VR/AR equipment 102 or the processing circuitry 122 of the mobile device 104 may determine an action to take based on the user input. The VR/AR equipment 102 may communicate signals, commands, instructions, or data to the control device 16, and the control device 16 may. It should be noted that the control device 16 may also receive data collected by the VR/AR equipment 102, and the processing circuitry 110 may determine actions to take based on the data received from the VR/AR equipment 102, such as whether to change an operation of the HVAC unit 12.

Additionally, the camera 144 may capture images and/or videos. The images and/or videos may be stored on the storage 138, the cloud 106, or both the storage 138 and the cloud 106. Moreover, images and videos obtained via the camera 144 may be sent to the mobile device 104 via the communication circuitry 140 and stored in the storage 126 of the mobile device 104. As discussed below, users of the VR/AR equipment 102 may interact with content collected using the camera 144. Furthermore, the camera 144 may be used to detect user input. For instance, hand motions or gestures may be detected via the camera 144, and processed by processing circuitry 134 and/or communicated to the mobile device 104 via the communication circuitry 140 for processing via the processing circuitry 122.

Moreover, in some embodiments of the HVAC system 100, the mobile device 104 may be included in the VR/AR equipment 102. For example in embodiments in which the mobile device 104 is a smart phone, the mobile device 104 may be inserted into a headset, and the processing circuitry 122 of the mobile device 104 may execute software instructions such as the application 120 to cause the mobile device 104 to provide virtual reality content via the display 130.

Communication within the HVAC system 100 may also involve the cloud 106, which, as illustrated, includes processing circuitry 146, non-volatile memory 148, storage 150, and communication circuitry 152. The processing circuitry 146 may execute instructions stored on the memory 148 or the storage 150, such as the application 120. In particular, the cloud 106 may manage the application 120; the control device 16, mobile device 104, and VR/AR equipment 102 may access the cloud 106 to send and receive data. For example, the storage 150 may include databases 154 onto which data received from the control device 16 and mobile device 104 may be stored. Likewise, the control device 16, mobile device 104, and VR/AR equipment 102 may access data that is kept in the databases 154 and storage 150. For example, while running the application 120, the mobile device 104 may utilize data stored on the cloud. As another example, the control device 16 may utilize data associated with the HVAC unit 12 in order to make determinations regarding how to control the HVAC unit 12. For instance, the control device 16 may access the storage 150 or databases 154 of the cloud to receive information regarding fan curves associated with the fans 32 of the HVAC unit 12 to determine how operation of the fans 32 should be adjusted in response to user input received via the VR/AR equipment 102, the mobile device 104, or the control device 16.

Other devices 156 such as computers, tablets, phones, or other electronic devices capable of connecting to the internet, may access the cloud 106 to utilize data received from the control device 16, the mobile device 104, and the VR/AR equipment 102 that is stored on the cloud 106. For example, as elaborated upon below, remote technicians may view data collected by the control device 16 as well as data collected via a technician inspecting the HVAC unit 12. However, it should be noted that the other devices 156 may be able to communicate with the mobile device 104 without using the cloud 106. For example, the mobile device 104 and other devices 156 may communicate via the internet.

With the foregoing in mind, the discussion will now focus on specific features of the application 120. FIG. 6 is a block diagram representative of various modules that may be included in the application 120. Data associated with the modules may be stored on the storage 150, and the modules may utilized by the control device 16, mobile device 104, and VR/AR equipment 102 by executing the application 120. Each of the modules may also be stored on the memory 112 and/or storage 114 of the control device 16, the memory 124 and/or storage 126 of the mobile device 104, and the memory 136 and/or storage 138 of the VR/AR equipment 102. Before discussing the modules individually, it should be noted that the modules may generally be categorized as modules that are unrestricted and those that are restricted. For example, modules 180 may be accessible to a device that can run the application 120, whereas modules 182 may be password or otherwise protected and/or may have features that are not generally accessible. For instance, access to the modules 182 may be based on a user input of an authorized user identification, which may include a username and/or password. More specifically, modules 182 may be accessible to technicians who may service, install, or otherwise perform work on the HVAC system 100, while modules 180 may be accessible to those who own the HVAC unit 12, such as a homeowner, as well as technicians. Moreover, in other embodiments, some of the modules 180 may be classified as modules 182, and some of the modules 182 may be classified as modules 180. Furthermore, execution of a given module may provide a user of the VR/AR equipment 102 with a user interface, information, and/or settings that are associated with the given module.

The modules 180 include a climate control module 190, a heating/cooling operation with fan control module 192, an HVAC system scheduling module 194, a video walkthroughs and user guides module 196, and an other functions module 198, which may include modules 180 included in the application 120. For instance, as discussed below, an example of another module 180 that may be included in the application 120 may be a library of motions or gestures associated with the application 120. The climate control module 190 relates to climate control functionalities associated with the HVAC system 100. For example, the climate control module 190 may include information regarding how the HVAC unit 12 operates and various temperature setpoints or differences in setpoints with a current temperature of the HVAC system 100. For instance, when an air temperature within a conditioned space associated with the HVAC system 100 differs from a temperature setpoint or other desired temperature setting, the control device 16 may activate the HVAC unit 12 to provide heating or cooling to the conditioned space. When interacting with the climate control module 190, a user may alter temperature setpoints of the HVAC system 100. For example, users may use the VR/AR equipment 102 to interact with the control device 16 in order to control operational settings of the HVAC system 100 and/or HVAC unit 12. Other settings associated with conditioned air in the HVAC system 100 may be modified by the user as well, such as air humidity settings.

The heating/cooling operation with fan control module 192 generally relates to a mode of operation of the HVAC system 100. For example, in some embodiments, the HVAC system 100 may operate in a heating mode, a cooling mode, or an automatic mode in which the control device 16 determines whether the HVAC system 100 should operate in the heating mode or the cooling mode. The heating mode refers to when the HVAC unit 12 operates to provide heated conditioned air to a conditioned space, and the cooling mode refers to when the HVAC unit 12 operates to provide cooled conditioned air to the conditioned space. When interacting with the heating/cooling operation with fan control module 192, users may select the mode of operation of the HVAC system 100. Moreover, users may modify fan settings of the HVAC unit 12.

The HVAC system scheduling module 194 relates to scheduling associated with the HVAC system 100. For example, a user may interact with the HVAC system scheduling module 194 to select certain days and/or times of the day when various temperature setpoints should be used. For instance, the user may set the HVAC system 100 to a higher or lower setpoint at times when the user does not wish for the HVAC system 100 to provide conditioned air to a conditioned space. Scheduling may be done by specific date and/or times, days of the week, months, and other classifications of time.

The video walkthroughs and user guides module 196 provides content to user to learn about the HVAC system 100. For example, when using the video walkthroughs and user guides module 196, users may access users manuals and video content that provide information about the HVAC system 100, such as how to use the control device 16 and/or the application 120. For instance, the user manuals and video content may teach users how to program the HVAC system 100 via the control device 16 and/or how to use the modules of the application 120.

The other functions module 198 relates to several other functions associated with the HVAC system 100 and control device 16. For example, the other functions module 198 may pertain to occupancy settings, zoning settings, and weather data. Users may alter settings for these functions. For example, in embodiments of the HVAC system 100 that include occupancy sensors, users may access occupancy controls related to control of the HVAC system 100 based on a detected occupancy or absence of people. Similarly, users may access zoning settings to set up and/or modify existing zones of a conditioned space as well as adjust heating, cooling, and other settings associated with zones. Additionally, the other functions module 198 may gain access to weather data, such as via the internet, and allow users to view outside weather conditions.

The modules 182, which may be password protected or to which access may be otherwise restricted, may include an electrical wiring diagrams module 200, a visual workshops module 202, a refrigerant charge verification and charging charts module 204, a software user guide module 206, an HVAC system troubleshooting instructions module 208, an HVAC system pressure and temperature data module 210, an HVAC system component specifications module 212, a piping and instrumentation diagrams and 3D models module 214, a technical service support and video conferencing module 216, and an HVAC system status and health module 218. The electrical wiring diagram module 200, when executed, may present users with electrical wiring diagrams associated with the HVAC unit 12. For example, the electrical wiring diagrams may be relevant to the installation or repair of the HVAC unit 12, the control device 16, or other components that may be included in the HVAC system 100, such as sensors.

The visual workshops module 202, when executed via the VR/AR equipment 102, may present a user with steps for performing various installation, maintenance, and repair activities associated with the HVAC system 100. For example, the user, which may be a technician, may be presented via the VR/AR equipment 102 with pictures or video content showing steps of the installation, maintenance, and repair activities. The content may be specific to the equipment of the HVAC system 100. For instance, when installing the HVAC unit 12, the VR/AR equipment 102 may display pictures or video content specific to the specific model of the HVAC unit 12 and/or components of the HVAC unit 12.

The refrigerant charge verification and charging charts module 204 may be executed via the VR/AR equipment 102 to enable the user to view information regarding components of the HVAC unit 12 and/or refrigerant used for implementing a thermal cycle. For example, viewers may be presented with information regarding superheating and subcooling of refrigerant in a vapor compression system, such as vapor compression system 72. Moreover, the user may be able to access charging charts associated with the HVAC unit 12. For instance, the charging charts may provide a relationship between outdoor temperatures, indoor temperatures, and superheating associated with the refrigerant; the user may view such charts using the refrigerant charge verification and charging charts module 204 of the application 120.

The software user guide module 206 may be executed to present the user with instructions regarding the application 120. For example, a user of the VR/AR equipment 102 may access the software user guide module 206 to view instructions and/or a manual regarding the application 120 and the various modules associated with the application 120.

The HVAC system troubleshooting instructions module 208 may be executed via the VR/AR equipment 102 to present troubleshooting instructions to a user of the VR/AR equipment 102. In particular, the troubleshooting instructions may include activities to perform in response to various system alerts or error notifications. The troubleshooting instructions may also pertain to both electrical and mechanical issues that may be encountered by the user of the VR/AR equipment 102. For example, the user may access troubleshooting instructions related to an air handler of the HVAC unit 12 to diagnosis an error with the air handler 12 as well as to resolve the error.

The HVAC system pressure and temperature data module 210, when executed via the VR/AR equipment 102, may provide pressure and temperature data associated with the HVAC system 100. For example, pressure data may pertain to air pressures in various portions of the HVAC unit 12 as well as a conditioned space to which the HVAC unit 12 supplies conditioned air. More specific examples of types of pressure data include suction pressure, which is a pressure that may occur at an intake of the compressors 42 when the compressors 42 are active, and discharge pressure, which refers to a pressure generated at an outlet of the compressors 42 when the compressors 42 are active. Additionally, temperature data may be related to temperatures associated with the HVAC unit 12 or the conditioned space.

The temperature and pressure data may be used for diagnostic purposes. For instance, the pressure and temperature data module 210 of the application 120 may include computer-executable instructions that cause pressure and temperature data, such as pressure and temperature feedback received from the HVAC system 100, to be analyzed according to one or more analysis algorithms. More specifically, pressure and temperature data may be analyzed to determine whether various error modes may be present. When an error mode is present, an alert may be present to the user via the display 142 of the VR/AR equipment 102.

The HVAC system component specifications module 212 may include diagrams and specifications of components that may be included in the HVAC system 100 or components thereof, such as the HVAC unit 12. In other words, the diagrams and specifications may be specific to parts that are included in the HVAC system 100. Information regarding the specific components of the HVAC system 100 may be stored on the storage 150 of the cloud 106, which, as discussed above, may be communicatively coupled to the VR/AR equipment 102 via the mobile device 104. As such, when a user utilizes the HVAC system component specifications module 212, information stored on the cloud 106 may be presented via display 142 of the VR/AR equipment 102. That is, a user of the VR/AR equipment 102 may use the HVAC system component specifications module 212 to access the diagrams and specifications of parts included in the HVAC unit 12.

The piping and instrumentation diagrams and three-dimensional (3D) models module 214 may include diagrams of piping and instrumentation included in the HVAC system 100. For example, a user of the VR/AR equipment 102 may view diagrams of piping associated with the HVAC system. For instance, the piping may include air ducts through which air is transferred throughout a conditioned space, and the piping of the HVAC system 100 may be shown in two-dimensional diagrams as well as three-dimensional models. As other examples, the piping may include refrigerant conduits or other fluid conduits included in the HVAC system 100. Piping within the diagrams and models may be color coded. For example, air ducts or piping used to transfer conditioned air to the conditioned space may appear one color, while air ducts used to transfer return air to the HVAC unit 12 may be presented in a different color.

Additionally, the piping and instrumentation diagrams and 3D models module 214 may enable users to view three-dimensional models of the HVAC system 100 as well as components thereof. For example, three-dimensional models of the HVAC unit 12 as well as parts included in the HVAC unit 12 may be viewed by users of the VR/AR equipment 102. Exploded views of components of the HVAC unit 12 may also be viewed. For example, in embodiments in which the VR/AR equipment 102 includes VR goggles, three-dimensional models of the components of the HVAC system 100 and HVAC unit 12 may be displayed in several types of views via the display 142 of the VR/AR equipment 102. Similarly, in embodiments in which the VR/AR equipment 102 includes AR glasses, three-dimensional models of the HVAC system 100 and components thereof may be presented while the user still has the ability to see his or her surroundings around him or herself.

Other views of the three-dimensional models and diagrams may also be provided or accessible. Users may also adjust a perspective of a three-dimensional model by using the VR/AR equipment 102. For example, the user may use a controller or other input device included in the VR/AR equipment 102 to adjust the perspective. Moreover, as described in more detail below, the user may use his or her hand and/or head to make gestures that can be recognized by the VR/AR equipment 102 as a request to change the type of view or a perspective from which a model is viewed.

The application 120 also includes the technical service support and video conferencing module 216, which may be used by users such as technicians to contact other technicians or remote parties for assistance. For example, the application 120 may allow for one technician to speak to or video conference with another technician via the internet. Additionally, before and during conversations and video conferences, content captured via the camera 144 of the VR/AR equipment 102 may be shared. For instance, a user of the VR/AR equipment 102 may have captured images or video content, both of which may be viewed remotely by another party. Additionally, live video content being captured the camera 144 may also be sent to a remote party. As such, the remote party may view the videos or photographs and provide assistance to the user of the VR/AR equipment 102.

More specifically, content captured via the camera 144 of the VR/AR equipment 102 may be sent to the storage 150 of the cloud before being accessed via the remote party. For example, the remote party may use one of the other devices 156 to view photographs or videos captured via the camera 144 as well as to conference with the user of the VR/AR equipment 102. Moreover, communication between the VR/AR equipment 102 and the other devices 156 may be facilitated via the mobile device 104. For instance, the VR/AR equipment 102 may be communicatively coupled to the mobile device 104 via the internet, Bluetooth, NFC, or other methods of communication such as through a physical connection like a Universal Serial Bus (USB) cord. In turn, the other devices 156 may be communicatively coupled to the mobile device 104 via the internet through a Wi-Fi connection or an LTE network, for example. As such, communication between the VR/AR equipment 102 and the other devices 156 may occur via the mobile device 104. Moreover, photographs and video collected via the camera 132 of the mobile device may be communicated to the other devices 156.

In some embodiments of the present application, photographs or videos may be edited by user interaction with the photographs or videos via the VR/AR equipment 102. For example, a user may highlight, draw on, or otherwise mark up images using hand gestures recognizable by the VR/AR equipment 102 or via a controller or input device of the VR/AR equipment 102. Content shared with remotes parties, such as those using the other devices 156, may be marked up using the other devices 156 as well. Such interactions with video and photographic content may be done during video conferencing. As such, parties to a video conference may collaborate on completing activities related to the HVAC system 100. For example, a technician attempting to diagnosis an issue with a component of the HVAC unit 12 may make a gesture to circle or highlight the component in an image, which will be edited to include the circling or highlighting. And, as described above, the image may then be shared with other parties, allowing them to see not only the image captured by the camera 132 or camera 144, but also edits made to the image.

Continuing the discussion of the application 120, the HVAC system status and health module 218 may perform analyses of data associated with the HVAC system 100 and provide alerts or notifications regarding the status and health of the HVAC system 100. For example, the HVAC system status and health module 218 may include algorithms that may be used to analyze temperature and pressure data, as well as other data collected via the HVAC system 100. The algorithms may pertain to various system faults or operating modes. For example, when a value matches or exceeds a predetermined threshold, a fault may exist. When a fault is determined to exist, an alert or notification may be displayed via the display 142 of the VR/AR equipment 102. The alert may be color coded or have a unique symbol indicative of the type of alert. For example, faults may pertain to whether maintenance activities should be performed and/or whether a particular component of the HVAC unit 12 may be malfunctioning or operating outside a desired range of parameters, among other things. For example, one alert may pertain to a compressor 42, while another alert may relate to refrigerant in the HVAC unit 12 or other components of the HVAC unit 12, such as the control panel 82 or the fan 36. For each of these types of faults, as well as other types of faults, a different visual alert may be presented via the VR/AR equipment 102. Additionally, the alert may be associated with a sound that may be communicated to a user.

When a fault is present, the fault may be selected by the user of the VR/AR equipment 102. For instance, the user may use a controller or input device associated with the VR/AR equipment 102 to make a hand or head gesture to make the selection. Upon making the selection, the user may be presented with more information about the alert. Such information may include content associated with other modules 192. For instance, instructions from the HVAC system troubleshooting instructions module 208 associated with the fault to which the alert relates may be presented via the VR/AR equipment 102 for the user to view and use to diagnose and/or resolve the fault. Additionally, an alert may include a suggested or recommendation action for addressing the alert. For instance, a fault associated with undesired component operation may include a suggestion to replace the component that is operating outside a desired parameter range.

Additionally, a fault history may be presented when an alert is selected. For example, the fault history may include a list of when the same type of fault was present. Moreover, users may be able to access a more general fault history library via the HVAC system status and health module 218 that provides a list of all fault occurrences.

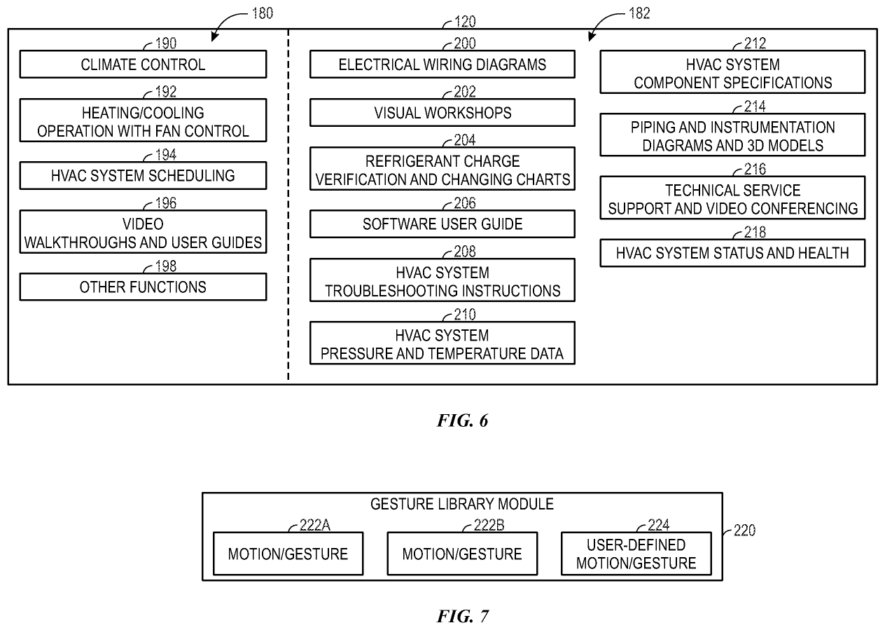

Other modules that may also be included in the application 120. For example, FIG. 7 is a block diagram of a gesture library module 220 that may be included in the application 120 and may store instructions regarding motions and gestures that a user may make. The gesture library may include motions or gestures 222 associated with a user's head, hands, and/or fingers. Examples of motions and gestures may include nodding, making a swiping motion, pointing, and many other motions and gestures. For instance, head nodding may be associated with a first motion or gesture 222a, and a finger or hand swiping motion may be associated with a second motion or gesture 222b of the gesture library module 220. Upon detected movement from a user, the VR/AR equipment may determine a gesture from the gesture library module 220 to which the user's movement corresponds. In some embodiments, the gesture library module 220 may not be accessible to users. That is, users may not be able to alter the gesture library module 220. However, in other embodiments, users may be able to alter the gesture library module 220 to customize the gesture library module 220. For example, in some embodiments, users may be able to define a new gesture or motion and a meaning associated with the new gesture or motion. The new gesture or motion and the associated meaning may then be stored in the gesture library module 220 as a user-defined motion or gesture 224, and the user may use the user-defined motion or gesture 224 when interacting with the application 120 via the VR/AR equipment 102, which will recognize the user-defined gesture or motion 224.

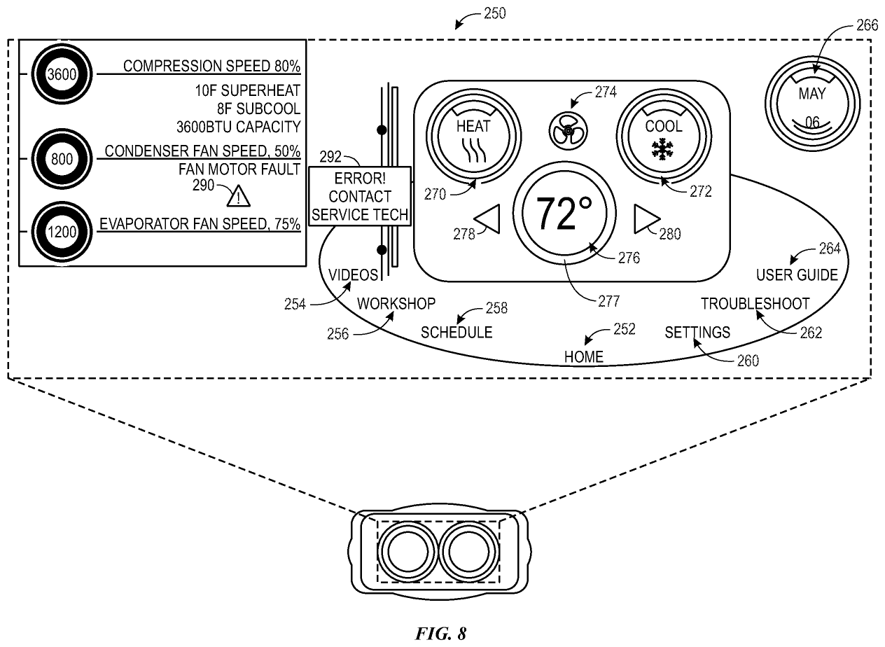

Keeping the discussion of FIG. 6 in mind, FIG. 8 is an illustration of a user interface 250 of the application 120 that may be presented to users of the VR/AR equipment 102, such as a pair of VR goggles. As illustrated, the user interface 250 includes a menu with various options of screens that a user may select. For example, the user interface 250 of FIG. 8 shows the home screen 252. Other screens that may be selected include a videos screen 254, a workshop screen 256, a schedule screen 258, a settings screen 260, a troubleshooting screen 262, and a user guide screen 264. In certain embodiments, each of the screens may be associated with one or more of the modules of FIG. 6. For example, a user may select the schedule screen 258, which may cause the HVAC system scheduling module 194 to be activated. The scheduling screen 258 may include features that allow the user to make scheduling decisions regarding the HVAC system 100.

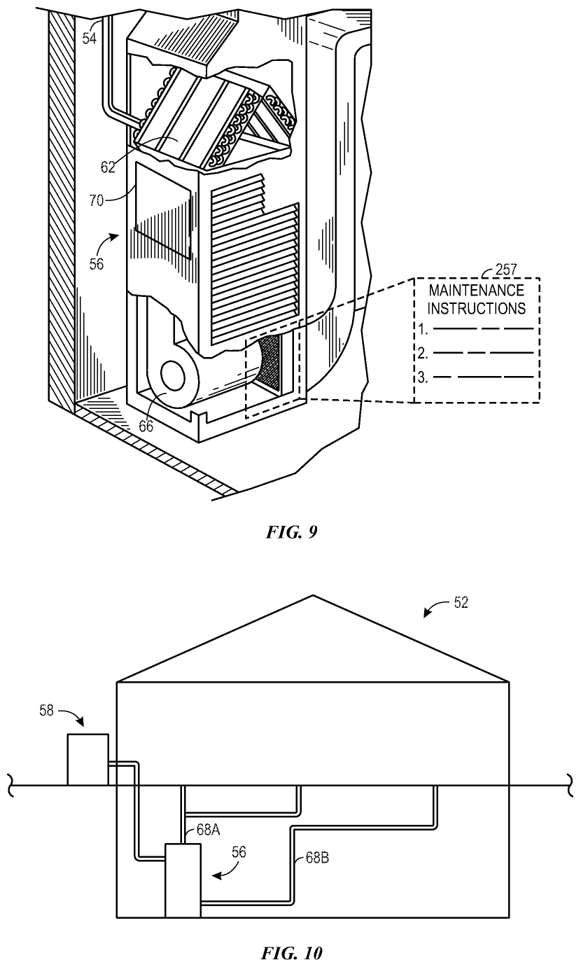

As another example, selecting the workshop screen 256 may cause the visual workshops module 202 to be activated. FIG. 9 is an illustration of content that the VR/AR equipment 102 may present to a user. As illustrated, a user may be presented with instructions 257 pertaining to the maintenance of a portion of the indoor HVAC unit 56. More specifically, in embodiments in which the VR/AR equipment 102 includes a virtual reality headset, the user of the VR/AR equipment 102 may be presented with types or models of HVAC units and the ability to select one of the types or models. Further information, such as the instructions 257 may be obtained by selecting a specific portion or component of the selected HVAC unit. In other embodiments in which the VR/AR equipment 102 includes augmented reality glasses, the instructions 257 may be presented via the VR/AR equipment 102 for a user to read while inspecting or working on the indoor unit 56. More specifically, in one embodiment, the VR/AR equipment 102 may include a pair of glasses that enables a user to view the indoor unit 56 therethrough, and the glasses may be configured to project an image of the instructions 257 onto a lens of the glasses, such that the instructions 257 appear to be superimposed adjacent to the indoor unit 56 viewed in real time by the user. In this manner, the user may be able to conveniently handle or interact with the indoor unit 56 while readily referencing the instructions 257 for working with the indoor unit 56.

Furthermore, selecting the workshop screen 256 may cause the piping and instrumentation diagrams and 3D models module 214 to be activated. For instance, the VR/AR equipment 102 may enable the user, upon selecting the workshop screen 256, to access piping and instrumentation diagrams as well as 3D models. FIG. 10 is a piping diagram of a residence 52 that the VR/AR equipment 102 may present to a user via the piping and instrumentation diagrams and 3D models module 214. As illustrated, ductwork 68 may be presented to the user. More specifically, portions of the ductwork 68 may be annotated or color-coded to indicate information about the various portions of the ductwork 68. For example, ductwork 68a may be presented in one color or annotated to indicate that the ductwork 68a is used for supply air, while ductwork 68b may be presented in another color or annotated to indicate that the ductwork 68b is used for return air. Additionally, in embodiments in which the VR/AR equipment 102 includes augmented reality equipment, the piping diagram or portions of the piping diagram may be presented as superimposed on the ductwork 68. For instance, a portion of the piping diagram may be projected onto the VR/AR equipment 102 such that the portion of the piping diagram appears to be positioned on top of the ductwork 68. In some embodiments, the piping diagram may be shaded or colored differently depending on various factors, such as a fluid that travels through a viewed portion of the ductwork, such as supply air or return air. Moreover, while FIG. 10 illustrates a residence, in other embodiments, users may be presented with information regarding HVAC systems in other settings, such as industrial or commercial buildings.

Returning to FIG. 8, the user interface 250 may also include a current date 266 that is presented to the user. The current date 266 may be obtained from the control device 16 or the mobile device 104, both of which may obtain the date from the internet.

The user interface 250 may also include a heating icon 270, a cooling icon 272, and a fan icon 274. Each of the icons 270, 272, and 274 may respectively illuminate or turn a predetermined color when the HVAC system 100 is heating, cooling, or circulating air. For example, when heated conditioned air is being supplied by the HVAC unit 12 to the HVAC system 100, the heating icon 270 may illuminate in a red color. Additionally, each of the icons 270, 272, 274 may be selected via user input to reveal settings and/or more information associated with the icons 270, 272, 274. For instance, selecting the fan icon 274 may cause information regarding a fan in the HVAC system to be presented via the VR/AR equipment 102.

A measured temperature or temperature setpoint may also be displayed on the user interface 250. For example, a temperature measured via the control device 16 may be presented in a temperature icon 276. The temperature icon 276 may be selected via user input, which may cause the VR/AR equipment 102 to display a screen with temperature setpoints, such as minimum and maximum temperature setpoints. Furthermore, whether the temperature reflected by the temperature icon 276 is within the minimum and maximum temperature setpoints may be indicated by a color of a ring 277 of the temperature icon 276. For example, when the displayed temperature is within a range of temperatures defined by the minimum and maximum temperatures, the ring 277 may be green. Yet, when the temperature in the temperature icon 276 is outside of the range of temperatures between the minimum and maximum temperature setpoints, the ring 277 may be a different color, such as red. Additionally, a user may select the arrows 278 and 280 to respectively decrease and increase temperature setpoints of the HVAC system 100.

Information regarding operations and/or the health of the HVAC system 100 may also be included in the user interface 250. For example, information regarding compressors, condenser fans, and evaporator fans in the HVAC system 100 may be displayed. Additionally, information such as superheat and subcooling associated with a refrigeration circuit of the HVAC system 100 may be presented. Furthermore, the user interface 250 may also include information regarding the number of British thermal units (BTUs) of thermal energy that the HVAC system can add to, or remove from, air within the HVAC system 100.

Errors or other notifications may also be presented on the user interface 250. For example, an error 290 may be presented indicating a fault detected, such as a fan motor fault. As described above users may select the error to receive more information regarding the error or for a recommendation of an action to take. For instance, a recommendation 292 to contact a service technician may be displayed on the user interface 250. In some embodiments, user input indicating a selection of the error 290 or the recommendation 292 may cause one or more of the modules 182 to be instantiated. For example, troubleshooting instructions associated with the HVAC system troubleshooting instructions module 208 may be presented. As another example, an option to initiate a video conference via the technical service support and video conferencing module 216 may be presented.

The techniques of the present application provide an HVAC system and virtual reality and augmented reality equipment configured for integration with the HVAC system. Accordingly, users of VR or AR equipment may use the VR and AR equipment to interact with control devices or other components of the HVAC system. For example, users may alter settings editable via the control device by using VR or AR equipment. Moreover, VR and AR equipment can be utilized to provide information regarding an HVAC system, such as data collected about the HVAC system, alerts associated with the HVAC system, and how to install, maintain, and repair the HVAC systems well as components thereof.

While only certain features and embodiments of the present disclosure have been illustrated and described, many modifications and changes may occur to those skilled in the art without materially departing from the novel teachings and advantages of the subject matter recited in the claims. For instance, the modifications and changes may include variations in sizes, dimensions, structures, shapes and proportions of the various elements, values of parameters such as temperatures or pressures, mounting arrangements, use of materials, colors, orientations, and the like. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described, such as those unrelated to the presently contemplated best mode of carrying out the present disclosure or those unrelated to enabling the claimed embodiments. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A climate management system, comprising:
a controller configured to control operation of the climate management system to control climate characteristics in a building; and
virtual reality or augmented reality (VR/AR) equipment comprising a display and configured to be communicatively coupled to the controller, wherein the VR/AR equipment comprises a memory device and a processor, and wherein the memory device includes instructions that, when executed by the processor, cause the processor to send a command to the controller based on a user input received with the VR/AR equipment.

2. The climate management system of claim 1, wherein the controller is a thermostat.

3. The climate management system of claim 1, wherein the instructions, when executed by the processor, cause the processor to display on the display a screen of a plurality of screens, wherein the plurality of screens comprises a home screen, a schedule screen, a settings screen, a user guide screen, a troubleshooting screen, or a combination thereof.

4. The climate management system of claim 1, wherein the user input comprises a physical button input, a touch screen input, a detected head gesture, a detected hand gesture, a detected finger movement, or any combination thereof.

5. The climate management system of claim 1, wherein the user input is indicative of a temperature setting change for the building, and the command comprises a signal to adjust operation of the climate management system.

6. The climate management system of claim 1, wherein the instructions, when executed by the processor, cause the processor to display, via the display of the VR/AR equipment, operation data for the climate management system, diagnostic data for the climate management system, technical support data for the climate management system, component specification data for the climate management system, or a combination thereof.

7. The climate management system of claim 1, wherein the instructions, when executed by the processor, cause the processor to display, via the display of the VR/AR equipment, technician support content based on input of an authorized user identification to the climate management system.

8. The climate management system of claim 7, wherein the technician support content comprises a piping schematic for the climate management system, an electrical wiring diagram for the climate management system, refrigerant charge information for the climate management system, or a video tutorial for the climate management system.

9. The climate management system of claim 1, comprising a mobile device, wherein the VR/AR equipment is configured to be communicatively coupled to the controller via the mobile device, wherein the mobile device comprises a cell phone, a smart phone, or a tablet.

10. The climate management system of claim 9, wherein the VR/AR equipment is configured to be communicatively coupled to the mobile device via Near-Field Communication (NFC) or Bluetooth.

11. The climate management system of claim 1, wherein the climate management system comprises a packaged heating, ventilation, and air conditioning (HVAC) system or a split HVAC system.

12. The climate management system of claim 1, wherein the VR/AR equipment comprises VR goggles or VR glasses.

13. A climate management system, comprising:
a control system configured to control climate characteristics in a building, wherein the control system comprises a memory device and a processor, and wherein the memory device includes instructions that, when executed by the processor, cause the processor to:
receive a user input via virtual reality or augmented reality (VR/AR) equipment;
control operation of climate control equipment via a thermostat of the climate management system based on the user input; and
display, via a display of the VR/AR equipment, a screen comprising operational information of the climate management system.

14. The climate management system of claim 13, wherein the operational information comprises temperature data of air supplied by the climate control equipment, temperature data of a conditioned space within the building, temperature setpoint data, airflow rate data, or any combination thereof.

15. The climate management system of claim 13, wherein the instructions, when executed by the processor, cause the processor to display technician support content via the display of the VR/AR equipment upon input of an authorized user identification, wherein the technician support content comprises a piping schematic for the climate management system, an electrical wiring diagram for the climate management system, refrigerant charge information for the climate management system, or a video tutorial for troubleshooting the climate management system.

16. The climate management system of claim 13, wherein the user input comprises a physical button input, a touch screen input, a detected head gesture, a detected hand gesture, a detected finger movement, or any combination thereof.

17. The climate management system of claim 13, wherein the user input is indicative of an adjustment to the climate characteristics of the building.

18. The climate management system of claim 13, wherein the instructions, when executed by the processor, cause the processor to:
capture an image of a component of the climate control equipment via a camera of the climate management system; and
superimpose a graphic on the image; and
display the image with the graphic via the display of the VR/AR equipment.

19. The climate management system of claim 18, comprising a mobile device comprising the camera.

20. The climate management system of claim 18, wherein the graphic comprises color shading, a schematic diagram, written instructions, or any combination thereof.

21. A climate management system, comprising:
a controller configured to control operation of a heating, ventilation, and air conditioning (HVAC) system to control climate characteristics in a building; and
virtual reality or augmented reality (VR/AR) equipment comprising a display and configured to be communicatively coupled to the controller via a mobile device and configured to control the HVAC system via the mobile device and the controller.

22. The climate management system of claim 21, wherein the display is configured to selectively display homeowner content and/or technician content based on an authorized user identification entered via the mobile device.

23. The climate management system of claim 21, wherein the controller comprises a thermostat.

24. The climate management system of claim 21, wherein the VR/AR equipment is configured to send a command to the controller via the mobile device based on an input received via the VR/AR equipment.

25. The climate management system of claim 24, wherein the input comprises a motion or gesture of a plurality of motions and gestures, wherein the plurality of motions and gestures is stored in a memory of the VR/AR equipment.

26. The climate management system of claim 25, wherein the plurality of motions and gestures comprises a user-created motion or gesture.

27. The climate management system of claim 25, wherein the motion or gesture is indicative of a desired change to the climate characteristics in the building.
